(19) United States
(12) Patent Application Publication
(10) Pub. No.: US 2008/0023955 A1
(43) Pub. Date: Jan. 31, 2008

(54) Cord brake

(76) Inventor: Martin Schautt, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/880,844

(22) Filed: Jul. 24, 2007

(30) Foreign Application Priority Data
Jul. 27, 2006 (DE) 10 2006 034 848.8

(51) Int. Cl. B60R 22/34

(52) U.S. Cl. 280/807

(57) ABSTRACT

There is described a brake, in particular a seat belt brake, for braking a component rotating about an axis of rotation with a brake body mounted on the axis of rotation, two bearing elements mounted on the axis of rotation and arranged one on each side of the brake body, and one brake cord or a plurality of brake cords which connect the two bearing elements in such a way that the brake body arranged between these is surrounded by the brake cord or the brake cords, and with an actuating device, which is in close contact with at least one of the bearing elements in such a way that the bearing elements can be shifted relative to one another in such a way that the brake cord or the brake cords come into frictional contact with the brake body.

### CROSS REFERENCE TO RELATED APPLICATIONS

This application claims priority of German application No. 10 2006 034 848.6 DE filed Jul. 27, 2006, which is incorporated by reference herein in its entirety.

### FIELD OF INVENTION

The invention relates to a brake for braking a component rotating about an axis of rotation, in particular a belt brake of an adaptive seat belt system in a motor vehicle.

### BACKGROUND OF THE INVENTION

Many examples of brakes of such a kind are known from the prior art. Band brakes and wedge brakes are for example known. In the case of so-called band brakes, a rotating body is braked by rubbing a brake band against said body. In the case of this principle also known as a cable brake, the braking torque M_{B} is calculated according to the following formula
M_{B}=M·e^{(β·μ)}, wherein
M: Band torque,
β: Angle of wrap of band around the body to be braked,
μ: Coefficient of friction between band and body.

In this way, the resulting braking torque increases exponentially with the product of the coefficient of friction μ and the angle of wrap β. When this happens, the band tensions around the body, whereby the movement of the body is braked in a self-energizing way.

Another brake principle is that of the wedge brake. An electromechanical brake for braking a motor vehicle with an electric actuator, which generates an actuating force that acts on a wedge, which is essentially shifted vertically to the axis of rotation is for example known from DE 198 19 564 C2. This wedge slides along an abutment so that a further shift component is obtained in the direction of the axis of rotation. Because of this, a frictional force is generated against the component to be braked, it being possible that the generated braking force is self-energizing because the wedge is taken along by the rotational movement of the body to be braked so that the braking force is energized as a result. As a function of the so-called wedge angle α (angle of inclination) and the coefficient of friction μ, a differentiation can be made between the push wedge arrangement and the pull wedge arrangement. If F_{R} denotes the frictional force resulting at the wedge and F_{IN} the input force exerted by the actuator on the wedge, the following applies

$$\frac{{F}_{IN}}{{F}_{R}} = - ( 1 - \frac{tan α}{μ} )$$

If μ and α are selected in such a way that the expression in parenthesis is negative over the entire operating range, then the input force F_{IN} over the entire operating range is positive (push wedge arrangement), whereas in the other case, the input force F_{IN} is negative, which is the reason why such an arrangement is also referred to as a pull wedge arrangement. In many cases, the push wedge arrangement is preferred to the pull wedge arrangement. Further particulars concerning this can be found in DE 198 19 564 C2.

Another kind of self-energizing electromechanical brake can be found in DE 101 64 317 C1. Instead of the wedge arrangement mentioned, a ball ramp arrangement is used here. In this case, a pressure plate can be shifted relative to an abutment in the circumferential direction of a brake disk to be braked, in which case the pressure plate has a friction lining on its other side, which acts on the brake disk. The pressure plate has tracks in the form of two ramps running in opposite directions. The abutment in turn also has a second set of tracks corresponding to and facing the first set. A ball or another rolling element is in each case incorporated between the corresponding tracks of the pressure plate and the abutment. On rotation of the pressure plate away from the abutment, the balls hence run up and down the relevant ramps whereby the distance between the abutment and the pressure plate is increased and, on the other hand, whereby the brake lining makes contact with the brake disk. Further information about this braking mode can be found in the said publication.

### SUMMARY OF INVENTION

Against this background, the underlying invention is based on an object of finding another braking mode, which in particular combines the advantages of the known and illustrated band brake and wedge brake and especially also has the corresponding characteristics as an option.

This object is achieved by a brake referred to as a cord brake. This essentially has the following elements: A brake body mounted on the axis of rotation, two bearing elements mounted on the axis of rotation and arranged one on each side of the brake body, and one brake cord or a plurality of brake cords which connect the two bearing elements in such a way that the brake body arranged between these is surrounded by the brake cord or the brake cords; furthermore, an actuating device, which is in close contact with at least one of the bearing elements in such a way that the bearing elements can be shifted relative to one another in such a way that the brake cord or the brake cords come into frictional contact with the brake body.

The main features of the operation of the described cord brake are as follows: The brake body arranged on the axis of rotation (torque-proof or rotatable) is in each case surrounded on one side by the bearing elements that are also mounted on the axis of rotation, in which case one brake cord or a plurality of brake cords connect the two bearing elements so that these so to speak “wrap around” the brake body in between. The bearing elements and the cord brake winding can be torque-proof or rotatable for their part, depending on whether or not the brake body is mounted in a torque-proof or rotatable manner about the axis of rotation. On rotation of the component rotating about the axis of rotation, there is a relative rotational movement of the bearing elements with brake cord winding on the one side and brake body on the other side, i.e. the brake body either rotates in the torque-proof brake cord winding or the brake cord winding rotates together with the bearing elements around the stationary brake body. In this state, the brake cord winding surrounds the brake body in an almost frictionless manner. By means of said actuating device, the bearing elements are now pushed against one another so that the brake cord winding comes into frictional contact with the brake body. By shifting the bearing elements relative to one another, the brake cord winding is tensioned and at the same time securely wrapped around or wound around the brake body and pressed or clamped securely against it. This results in a strong braking of the rotational movement.

At this point, it should be mentioned that the indefinite article (“a/an”) in the present application, especially in the claims, is not used in the sense of “a single”, but in the sense of “at least one”.

In a first advantageous embodiment, the brake body is mounted in a rotatable manner about the axis of rotation and is connected to the rotating component. This connection can be made in a direct or in an indirect (interconnection of a coupling or a gear) way. In this case, it is advantageous and sufficient for one of the two bearing elements to be mounted in a rotatable manner about the axis of rotation, while the other one is mounted in a torque-proof manner. The bearing element that is mounted in a rotatable manner is then subjected to a corresponding force from an actuating device, which causes it to shift away from the first bearing element. Naturally it is also possible to mount both bearing elements in a rotatable manner and to connect these with an actuating device or one actuating device each.

In principle, the relative shift of the two bearing elements by the actuating device takes place in a rotational sense, i.e. an angular displacement is produced. However, a translatory shift is in principle also feasible primarily for the most part in the direction of the axis of rotation, in which case the two bearing elements move away from one another. In order to produce an angular displacement, the bearing elements are rotated towards one another so that the brake cords are tensioned in the corresponding direction. On the basis of this angular displacement, the projected length of every brake cord section between the two bearing elements on the axis of rotation is reduced as the angular displacement increases. In this way, the tight winding of the brake cord or the brake cords act in the same way as a normal force and for this reason, it exerts a braking force (frictional force) on the brake body. In the case of the brake cord winding it should be mentioned that said winding could be made from individual brake cords, in which case one brake cord in each case connects the first bearing element to the second bearing element. Alternatively, one single brake cord can also be used, which is spanned from bearing element to bearing element in each case and surrounds both sides of the brake body. Combinations of the said arrangements are also conceivable.

A bearing disk or a bearing ring or combinations of these can be used as the bearing element. A plurality of such bearing elements with a plurality of brake cord windings is also conceivable when this is practical. Finally, a plurality of brake bodies with the bearing elements and brake cord windings associated therewith can also be connected in series to reinforce a braking action.

In another embodiment, the brake body is mounted in a torque-proof manner about an axis of rotation. In this case, both bearing elements must be mounted in a rotatable manner about the axis of rotation. This makes it possible for the two bearing elements to rotate together with the brake cord winding around the brake body that is mounted in a torque-proof manner, it being possible in the same way as in the first embodiment to achieve a braking action by an angular displacement of the two bearing elements to one another. In this case, the rotational movement of the rotating bearing elements is braked. In order that the braking action can be transferred to the component to be braked, at least one of the bearing elements is connected either directly or indirectly to the component to be braked in an advantageous manner. Depending on how firmly the brake cord is wound, the rotation of the one bearing element can be transferred to the other bearing element so that both bearing elements rotate in the same direction as the component to be braked (at the same speeds or at fixed speeds relative to one another).

In an expedient development of the said second embodiment, (at least) one of the two bearing elements of (at least) one drive unit can be driven so that a forced rotation about the axis of rotation takes place. In the case of this development one of the two bearing elements can for example be connected mechanically to the rotating component, while the other bearing element is driven by a drive unit, for example a motor, rotating in the same direction at the same speed. In this case, both bearing elements rotate around the fixed brake body together with the brake cord winding. As long as the drive unit maintains the same angular velocity as that of the rotating component, an (almost) frictionless rotation of the brake cord winding around the brake body is obtained. On the other hand, in order to initiate a braking process, an angular displacement between both bearing elements must be produced. For this purpose, the speed of the drive unit can be controlled or regulated in such a way that, at least for a short time, this speed no longer corresponds to the speed of the rotating component. For this purpose, it is for example sufficient to reduce the motor speed of the drive unit for a short time. In this case, the said actuating device for generating an angular displacement is integrated in the drive unit (motor). However, it is also conceivable to generate the angular displacement by an additional actuating device, which acts on one of the two bearing elements, in order to generate the said speed difference or the angular velocity difference. Because of a change in the speed for a short time, one bearing element rotates somewhat further than the other one, as a result of which the said angular displacement sets in accordingly. Because of this, as described above, the brake cord winding is tensioned and a braking force is produced on the stationary brake body.

It should be noted that in order to change the speed, the speed of one of the bearing elements could be reduced, but also increased. For this purpose, the drive unit, which drives one of the two bearing elements, can be operated for a short time at a higher or a lower motor speed. In order to increase or to reduce the braking force again, the angular displacement between the two bearing elements must be decreased. For this purpose, the drive unit (motor) can again be activated in such a way that the motor speed is correspondingly increased or reduced for a short time. In order to reduce the motor speed of the drive unit, a simple control of the motor is sufficient, which for example decreases the current intensity. However, it is also conceivable to replace the control with a regulating device or to equip the motor with an additional brake.

This arrangement comprises an inherent mechanical control circuit. If the bearing element connected to the rotating component makes an attempt to rotate more quickly than the bearing element connected to the drive unit, the braking torque will increase. Therefore, the desired speed can be specified on the part of the drive unit and the brake automatically generates the braking torque required to slow down the relevant component to said speed.

Should it not be possible to maintain the specified speed because the load is braked from the outside (higher resistance), the resulting angular displacement would lead to a further braking of the load and thus to a negative self-energizing. A limit stop can for example be provided as a counter measure, which limits the difference angle during reverse travel. The brake can then not draw together and the load thus brakes the motor to a synchronous speed.

It should be mentioned at this point that the drive unit and/or the actuating device could use an additional gear mechanism for converting the torque and the rotational speed. Moreover, any kind of emergency release device is feasible (for example, a coupling that is integrated in the shaft which connects the rotating component and the one bearing element) in order to prevent an undesired jamming of the brake. Another possibility of an emergency release device is described further below.

Preferably the brake body is of a symmetrical design. A round, for example, torus-shaped (toroidal) form is best. Because of this, a rotation that is as steady as possible can be guaranteed (provided the brake body is mounted in a rotatable manner). In addition, the brake body should have a smooth surface so that the brake cord winding can wrap continuously around the brake body without becoming damaged. It has been shown that the braking response can also be determined by the geometry of the brake body to a considerable extent.

Advantageously the bearing elements have connecting elements that serve to fasten the brake cord or the brake cords. To this end these connecting elements can be of various kinds: (for the sake of simplicity, only one brake cord will be referred to here). It is possible to thread or to wind up or to fasten the brake cord using eyelets as connecting elements distributed over the circumference of the bearing element or to thread or to wind up or to fasten using hooks as connecting elements (cf. Principle of fastening a shoelace on a shoe: Shoelaces with eyelets for example plain lace-up shoes or shoelaces with lace-up hooks, for example, for hiking boots). On the other hand, the brake cord can be wound around a ring, which is mounted in the hook of the bearing element distributed over its circumference. As a matter of course, a plurality of cords can be used instead of one brake cord and a plurality of rings instead of one ring.

It is also practical when the brake cord or the brake cords surround the brake body equidistantly. In this case, it must be understood that the relevant brake cord sections, which run from one bearing element to another bearing element, run parallel and equidistantly to one another. In essence, the said sections can be vertical to the main levels running on the bearing elements, which in essence, on their part, run vertically to the axis of rotation (in other words, said brake cord sections then run parallel to the axis of rotation). In this case, an angular displacement in one of the two directions of rotation then likewise leads to the braking action as described above.

In an advantageous embodiment of the brake cord, at least one of the bearing elements is mounted in a displaceable manner in the direction of the axis of rotation. That is to say that because of this translatory displaceability, the bearing element can be used to generate an additional braking force. Because of the above-mentioned shortening of the brake cord sections in their projection on the axis of rotation, in the case of an angular displacement generated during braking, the bearing element is inevitably pulled towards the brake body. Consequently, at least one of the bearing elements on the side facing the brake body can be provided with a friction lining which, during braking, presses against the brake body in an axial direction and applies a normal force in an advantageous manner. Because of this, the braking force generated by the brake cord winding can be increased further. It is practical to mount either both bearing elements or one of the bearing elements and the brake body in a translatory displaceable manner.

Another advantageous embodiment of the brake cord relates to an emergency release device, which can open a brake that is threatening to jam or a brake that has already jammed. For this purpose, at least one of the bearing elements presses against the brake body by means of a bearing (as a matter of course, a friction lining is not sensible for the relevant bearing element in this case). The bearing can be a ball bearing, a roller bearing, etc. The bearing is used in a bearing element which is preferably driven by a drive unit. Should the brake jam because it for example gets into the tension range and can no longer be released on account of the self-energizing, the bearing element that rolls onto the brake body because of the bearing can be adjusted with relatively small adjusting forces or adjusting torques by means of the drive unit in such a manner that the brake cord or the brake cord winding clamped securely over the brake body is loosened and the braking action is cancelled.

A few characteristics of the described cord brake are discussed below:

Self-energizing: Because the brake cord or the individual brake cord sections tension during a braking at an angle α (referred to the direction of the axis of rotation) around the brake body, a drag effect is formed on the basis of the rotation of the brake cord relative to the brake body and the resulting frictional force, which in addition tensions the brake cord. This additional tensioning again increases the frictional force and for this reason the braking force. The brake energizes itself in this way.

Angle of wrap: An important parameter of the described cord brake is the angle of wrap β. Said angle describes the actual wrapping of the brake cord around the brake body and can for example be influenced by the geometrical arrangement of the connecting elements at the bearing elements. For this purpose, the following exemplary embodiment is referred to with reference to FIG. 2. In addition, angle β depends on said angle α. The greater α, the greater β. The relation between the angle of wrap β and the braking force is similar to that of the exemplary principle of a ship's mooring rope by means of which, the greater the frictional force (=braking force) achieved, the more rope is wound or wrapped around a post or a mooring post. For this purpose, the exemplary embodiment is also in particular referred to with reference to FIG. 4.

Cord length and size of the brake body: Both the length of the brake cord, which means the length of a brake cord section between the two bearing elements, and the size of the brake body are important parameters that influence the braking action. By changing these parameters, different tendencies can be achieved in the braking action. In the case of a large friction surface, i.e. if the brake body surface that can actually be used is large, and there is a correspondingly long brake cord that is wound around the brake body, high frictional and braking forces can be achieved. However, on the other hand, relatively small adjusting angles, or angular displacements of the bearing elements and for this reason a slight tensioning of the brake cord will be sufficient for actuating heavy braking. A large brake body surface also improves the dissipation of frictional heat. The length of the brake cord (in the definition applicable in this paragraph) can (relative to the actual brake body surface) influence the response of the brake. If a relatively short brake cord is selected, then the adjusting angles a must be relatively large and the brake tends to exhibit a wedge braking response (cf. exemplary embodiments with reference to FIGS. 3 and 5). If a relatively long brake cord is selected, then the adjusting angle α must be relatively small for braking and the brake tends to exhibit a band braking response, which for the main part depends on the angle of wrap β (see above, and the exemplary embodiment with reference to FIG. 4). It is advantageous to dimension the single length of the brake cord section running over the brake body in such a way that the braking response is within the transition area between the wedge braking response and the band braking response. The optimum design point of the cord brake according to the invention lies within the area of this transition (at the turning point from wedge braking response to band braking response). In this transition area, the cord length has only a very small influence on the self-energizing

$${C}^{*} = \frac{{M}_{B}}{{M}_{M}} ,$$

wherein M_{B} refers to the braking torque and M_{M} the motor torque.

Further possible developments are outlined below:

One of the bearing elements (bearing disk, wheel bearing, or the like) can be integrated in the component to be braked; the other bearing element can be integrated in the said actuating device in the same way. Because of this development, the number of components required can be reduced. It depends on the type of component to be braked and on the actuating device.

The brake cord, in the narrow sense, instead of in the form of a cord, can also be in the form of chains, wire ropes, or woven patterns (in the same way as a lengthwise woven carpet).

It is practical when the brake body has one friction lining or a plurality of friction linings on the side facing the brake cord winding. By using such brake linings applied to the circumference of the brake body, the service life can be increased because, in this case, the brake lining then wears away and not the brake cord.

Finally, it can be useful for the brake body to be mounted by means of a freewheel about the axis of rotation. With this embodiment the brake body is only mounted in a torque-proof manner in one direction of rotation, with a rotational movement in the opposite direction being possible because of the freewheel. The freewheel can preferably be integrated in the brake body. An integration at another location, for example, in a fixed bearing to which the brake body is connected mechanically, is likewise possible. Mounting the brake body by means of such a freewheel obtains the function of the brake for that direction of rotation, for which a rotation of the brake body is prevented (cf. second embodiment in the description above). However, a rotation of the brake body in the opposite direction is possible, which can be usefully applied in certain cases. For example, when a belt brake is used, the winding off action of the seat belt from the retractor reel must be braked in the event of a crash (seat belt brake). In this way, the payout of the seat belt can be regulated. On the other hand, on detecting a crash, the seat belt is immediately tensioned so that it presses and lies uniformly against the occupants inside the motor vehicle (seat belt tensioner). Subsequently, in the case of seat belt tensioning, a movement of the retractor reel in one direction of rotation is necessary, which is in the opposite direction of that of winding off the seat belt. By means of the mentioned development of mounting the brake body by means of a freewheel, it is possible to implement a braking of the retractor reel in the direction in which the seat belt is wound off as well as vice versa, a seat belt tensioning with one single braking system. For further explanations of this development, please refer to the exemplary embodiment with reference to FIG. 8.

The described cord brake is suitable for the widest variety of application areas in which rotating components must be braked. Materials that may be considered for a brake cord are carbon fibers or aramid fibers. Another advantage is, that with regard to the accuracy of parts, production and assembly accuracy, high tolerance requirements are not necessary. For a controlled braking, control of the motor is sufficient and closed-loop control of the motor is not mandatory. This simplifies the activation of the brake. As explained above, the brake is self-energizing and can be optimized with the aid of the brake body geometry and cord length parameters.

### BRIEF DESCRIPTION OF THE DRAWINGS

The explained features cannot just be used in the combination shown here, but also in other combinations as well as individually in so far as practical. Exemplary embodiments of the invention and their advantages are explained in more detail below with reference to the enclosed, schematic figures.

In the figures:

FIG. 1 shows schematically the design of an embodiment of a cord brake,

FIG. 2 shows a detailed view of a brake cord from FIG. 1 in the case of an inactive brake,

FIG. 3 shows an analog view of FIG. 2 in the case of an inactive brake,

FIG. 4 shows the basic diagram of a band brake,

FIG. 5 shows the basic diagram of a wedge brake,

FIG. 6 shows a schematic perspective view of a brake cord wound over a brake body in the case of a cord brake,

FIG. 7 shows a cross-sectional view of a cord brake,

FIG. 8 shows the use of a cord brake as a belt brake with an integrated seat belt tensioner.

### DETAILED DESCRIPTION OF INVENTION

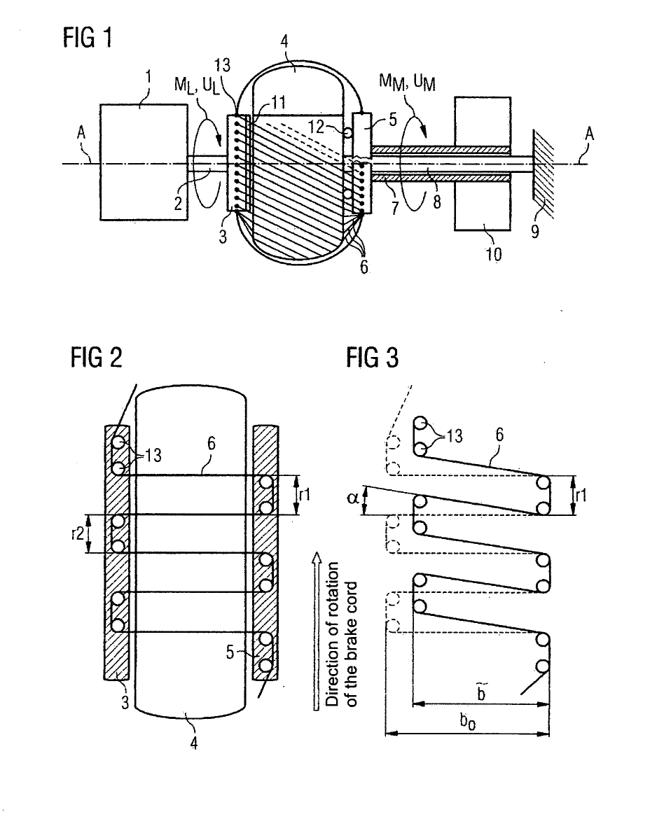

FIG. 1 shows schematically an embodiment of the invention which is described in the above description as the second embodiment. The component or the load to be braked is labeled 1. The brake body is labeled 4 and the bearing elements surrounding it on the sides, namely bearing disks here, 3 and a 5. A diagram of the brake cord winding surrounding the brake body is shown, wherein the brake cord or the brake cords are labeled 6. The actuating device for shifting the bearing elements 3 and 5 relative to one another is labeled 10. The actuating device 10 can be a motor. The brake body is mounted in a torque-proof manner about the axis of rotation A while it is mechanically connected to a fixed bearing 9 via a connecting shaft 8. The two bearing elements or bearing disks 3 and 5 are in each case mounted in a rotatable manner about the axis of rotation A. In this case, the bearing disk 3 is securely connected to the component 1 by means of a shaft 2 so that the bearing disk 3 moves at the same speed as that of component 1. The bearing disk 5 is driven by the actuating device or the motor 10 through a hollow shaft 7. The direction of rotation and the speed correspond with that of the component 1 to be braked. In this way, the brake cord winding and the two bearing disks 3 and 5 formed by the brake cords 6 rotate altogether around the stationary brake body 4. In this case, M_{L} and U_{L} refer to the load torque or the on-load speed that is transferred from the component 1 by means of the shaft 2; M_{M} and U_{M} the motor torque or the motor speed that is transferred from the motor 10 to the bearing disk 5 through the hollow shaft 7.

It should be noted again at this point that the mechanical connections between the bearing disks 3 and 5 to the load or to the component 1 or to the actuating device or to the motor 10 can be made in a different mechanical way than that shown in FIG. 1. In particular, the intermediate connection of gears and couplings is possible. For further embodiments the reader is referred to the preceding description.

The operation of the cord brake shown in FIG. 1 will now be explained. It should first of all be assumed that the brake is in an inactive, non-tensioned state or in an open state in which the brake cords 6 surround the stationary brake body 4 non-tensioned and almost frictionless (cf. FIG. 2). For this purpose, it is necessary for the two bearing disks 3 and 5 to rotate at the same speed, i.e. U_{L}=U_{M}, so that the brake cord or the brake cords 6 are not tightly wound and in this way do not exert a frictional force on the brake body 4. Therefore, if the component/load 1 rotates at a certain rotational speed U_{L}, the motor or the drive unit 10 must rotate at the same speed so that the brake cords 6 cannot be tightly wound. For this purpose, the speed of the component 1 can be determined by a sensor and used to control or regulate the motor 10. On the other side of the brake body 4, the bearing disk 3 rotates at the speed U_{L} of the component 1. In this way, the brake cord 6 that is connected to the bearing disks 3 and 5 (it can also be individual brake cords) by means of the connecting elements 13, is taken along by the bearing disks 3 and 5 and likewise rotates at the same speed around the brake body 4.

To enable the brake cord 6 to now exert a braking force on the brake body 4, an angular displacement must be produced between the two bearing disks 3 and 5 so that the brake cord 6 is tensioned and at the same time securely wrapped around or wound around the brake body 4 and pressed or clamped securely against it. By rotating the bearing disks 3 and 5 relative to one another, the connecting elements 13 located on the bearing disks, at the same time, rotate relative to one another so that the brake cord 6 is essentially tensioned diagonally (compare FIG. 1 and FIG. 3) with regard to the axis of rotation A.

The angular displacement between the two bearing disks 3 and 5 needed for braking is for example produced in a simple way because of the fact that the speed of the drive unit or of the motor 10 is controlled (or regulated) in such a way that it no longer corresponds with the speed of the component or the load 1, i.e. U_{L}≠U_{M}. For this purpose, it is for example sufficient, in the case of a load 1 that is rotating, to reduce the motor speed U_{M} of the motor 10 for a short time. Because the speed of U_{M} was changed for a short time, the bearing disk 3 turns somewhat farther than the bearing disk 5 (as long as the speed U_{M} is reduced), as a result of which an angular displacement between the two bearing disks 3 and 5 sets in accordingly. Because of this, as described above, the brake cord 6 is tensioned at the same time and creates a braking force on the brake body 4.

In principle, it could also be possible for braking to increase the motor speed U_{M} compared with the on-load speed U_{L} (U_{L}≠0). However, this possibility will not be explained in greater detail below.

In order to relieve or reduce the braking force of the brake cord again, the angular displacement between the two bearing disks 3 and 5 must be cancelled or decreased. For this purpose too the control of the motor 10 is used in an analogous way, in that the motor speed is accordingly increased again for a short time.

In principle, in order to reduce the motor speed U_{M}, a simple open-loop control of the motor 10 is sufficient, which for example, reduces the current intensity of the motor 10. However, in practice, a closed-loop control could also replace the open-loop control or the motor 10 could also be equipped with an additional brake.

In addition to this basic function of the cord brake, additional practical developments will be explained with the aid of FIG. 1: For this purpose, reference is first of all made to FIGS. 2 and 3. FIG. 2 shows the position of the brake cord 6 in an inactive braking state, i.e. in a non-tensioned brake cord. In the case of the embodiment shown, a brake cord 6 is tensioned between the bearing disks 3 and 5 by the connecting elements 13 winding around and holding the brake cord 6. Naturally developments in f which individual brake cords are in each case tensioned from the one bearing disk 3 to the other bearing disk 5 are also feasible. According to FIG. 2, the connecting elements 13 are arranged in the embodiment in pairs, it being possible for two connecting elements 13 of a pair of connecting elements on the bearing disk 3 to have the distance r₂, while the connecting elements 13 of a pair of connecting elements on the bearing disk 5, are at the distance r₁ to one another. An equidistant arrangement of the brake cord sections, which stretch between the bearing disks 3 and 5, is obtained when r₁=r₂. In the drawing according to FIG. 2, said brake cord sections are in essence parallel to the axis of rotation A, whereas the direction of rotation of the brake cord winding (cf. FIG. 1) is at right angles to this. The brake body is again labeled 4 in FIG. 2.

FIG. 3 shows the situation in the case of an activated brake, with the initial situation of FIG. 2 being shown by a broken line to make a comparison easier. As shown in FIG. 3, an angle α is produced between the axis of rotation A and the curve of the brake cord 6 (more accurately, the brake cord sections), which results from the angular displacement of the bearing disks 3 and 5 when the brake cable 6 is tensioned at the same time. On the basis of the resulting diagonal winding of the brake cord 6 around the brake body 4, the length of the brake cord 6 (more accurately, the brake cord section) projected onto the axis of rotation A is shortened in the case of an increasing angle α by the amount b₀-\tilde{b}. In this case, b₀ refers to the length of the brake cord section in the case of an inactive brake (compare FIG. 2) and \tilde{b} to the brake cord section in the case of an active brake projected onto the axis of rotation A. It is thus evident how the tensioning or the tensioning force of the brake cord means that the latter exerts a normal force and for this reason a braking force (frictional force) on the brake body 4. By the brake cord 6 fitting tightly against the brake body 4, a frictional force is generated. In this case, it is advantageous to equip the surface of the brake body 4 with a friction lining to counteract an abrasion of the brake cord 6.

Returning to possible developments of the cord brake according to FIG. 1, the shortening of the projected cord length described with reference to FIGS. 2 and 3 can be used for an additional generation of the braking force when the brake is activated. That is to say, if at least one of the two bearing disks 3 and 5 is mounted on the mechanical connection 2 or 7 associated therewith in a translatory displaceable manner, then the relevant bearing disk can generate an additional braking force. In the present case, this will be illustrated with the aid of the bearing disk 3 which is provided for this purpose with a friction lining 11 on the side facing the brake body 4. On the basis of shortening the brake cord sections from b₀ to \tilde{b} and the translatory displaceability of the bearing disk 3, this bearing disk 3 is drawn closer to the brake body 4. Because of this, the friction lining or the brake lining 11 is pressed in an axial direction against the brake body 4, whereby a normal force is generated, which reinforces the braking action. Naturally the other bearing disk 5 can also be provided with a friction lining for this purpose.

In a further advantageous development, the brake shown in FIG. 1 is provided with an emergency release device, which can open a brake that is threatening to jam or a brake that has already jammed. For this purpose, one of the bearing disks 3 or 5, advantageously bearing disk 5, instead of having a brake lining, is equipped with an additional bearing 12 (cf. FIG. 1) such as a ball bearing or a roller bearing. Should the brake jam because it for example gets into the tension range and can no longer be released on account of the self-energizing, the bearing disk 5 that rolls onto the brake body 4 because of its bearing 12, can be adjusted with relatively small adjusting forces or adjusting torques by means of the motor 10, in such a manner, that the brake cord 6 that has already been clamped securely over the brake body 4 is loosened and the braking action is cancelled. In this manner, an emergency release device can be used with relative ease in the case of a cord brake.

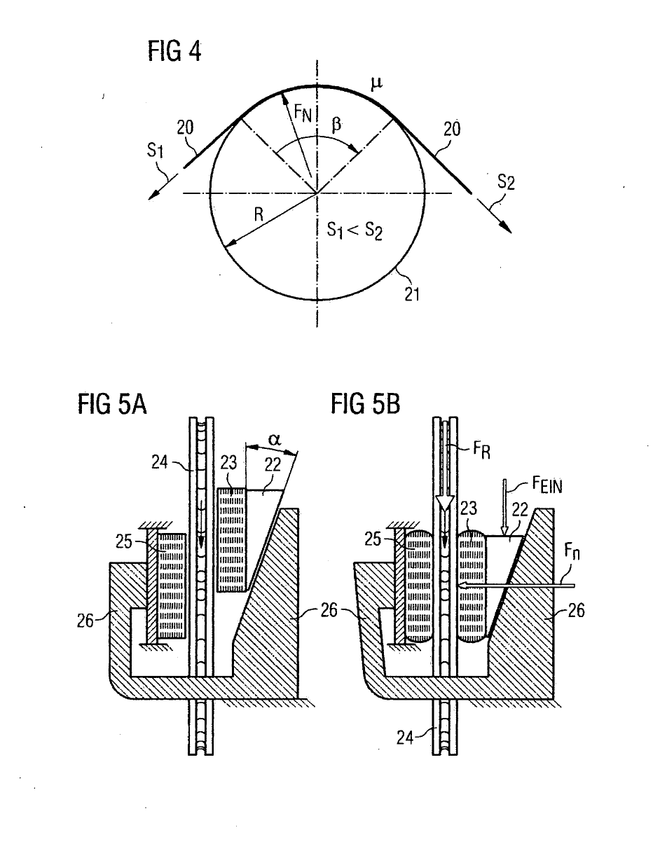

FIG. 4 illustrates the operation of a band brake or a cable brake, as is known per se. An important parameter of the cord brake is the angle of wrap β. This describes the actual wrapping of the brake cord 6 around the brake body 4 and can for example be influenced by the geometrical arrangement of the connecting elements 13 (see FIGS. 2 and 3). If relatively long distances r₁ and/or r₂ are selected from FIG. 2, a relatively small angle of wrap β is obtained. For this purpose, the distances r₁ and r₂ can be set with reference to the distance between the bearing disks 3 and 5. In addition, the angle β depends on the angle α (compare FIG. 3). The greater a, the greater β. In this way, short distances r₁ and r₂ and large angles α, together result in a large actual angle of wrap β. The relation between the angle of wrap β and the braking force is similar to that of the exemplary principle of a ship's mooring rope by means of which a greater frictional force or braking force is achieved, the longer the rope that is wound or wrapped around the mooring post.

In the sketch shown in FIG. 4, the frictional force comprises the product of the coefficient of friction μ and the normal force F_{N}. The forces acting on the rope 20 are on the equilibrium side S1 and on the load side S2. It can be shown that the following relations apply for the occurring forces:

$${F}_{N} = \frac{{S}_{1}}{μ} \cdot ( {ⅇ}^{μ β} - 1 ) ; \frac{{S}_{1}}{{S}_{2}} = {ⅇ}^{μ β}$$

In this way, the frictional force increases exponentially with the product of the coefficient of friction μ between the rope 20 and the mooring post 21 and the angle of wrap β. As is shown, the cord brake has characteristics of the shown cable brake or the band brake in certain operating ranges.

FIG. 5 shows the basic diagram of a known wedge brake. FIG. 5A shows the opened wedge brake and FIG. 5B the closed wedge brake. In certain operating ranges of the cord brake, characteristics of the wedge brake shown in FIG. 5 can be implemented. For the operation of the wedge brake shown here, reference should be made to DE 198 19 564 C2 discussed in the introduction to the description. In FIG. 5, the wedge moved by an actuator is labeled 22. It carries a friction lining labeled 23, which in the closed state (FIG. 5B) presses against the brake disk labeled 24. The wedge 22 rests against an abutment 26. All told, a sliding caliper design is shown in FIG. 5, which is mounted in the direction of the axis of rotation in a sliding manner so that a pressure of the wedge 22 or the friction lining 23 leads to a pressure of the friction lining 25 on the side facing the abutment 26 on the brake disk 24. With F_{R}=μFₙ (relation between the frictional force and the normal force), the relation, shown in the introduction to the description, between the input force F_{IN} exerted by the actuator (not shown) on the wedge 22 and the normal force Fₙ shown in FIG. 5 is obtained, which depends on the wedge angle α which is shown in FIG. 5A and the coefficient of friction μ between the friction lining 23 on the wedge 22 and the brake disk 24.

Referring to FIGS. 2 and 3, the length of the brake cord 6 (relative to the brake body dimensions) can now be changed and in this way the response of the brake can be influenced: If a relatively short brake cord is selected, then the adjusting angle α must be relatively large between the bearing disks 3 and 5 (see FIG. 3) and the brake tends to exhibit a wedge braking response. However, if a relatively long brake cord is selected, then the brake tends to exhibit a band braking response, which depends on the angle of wrap β (compare FIG. 4 with reference to the FIGS. 2 and 3). The optimum design point of the brake lies within the area of transition between the wedge braking response and the band braking response. In this transition area, the cord length has only a very small influence on

$${C}^{*} = \frac{{M}_{B}}{{M}_{M}} .$$

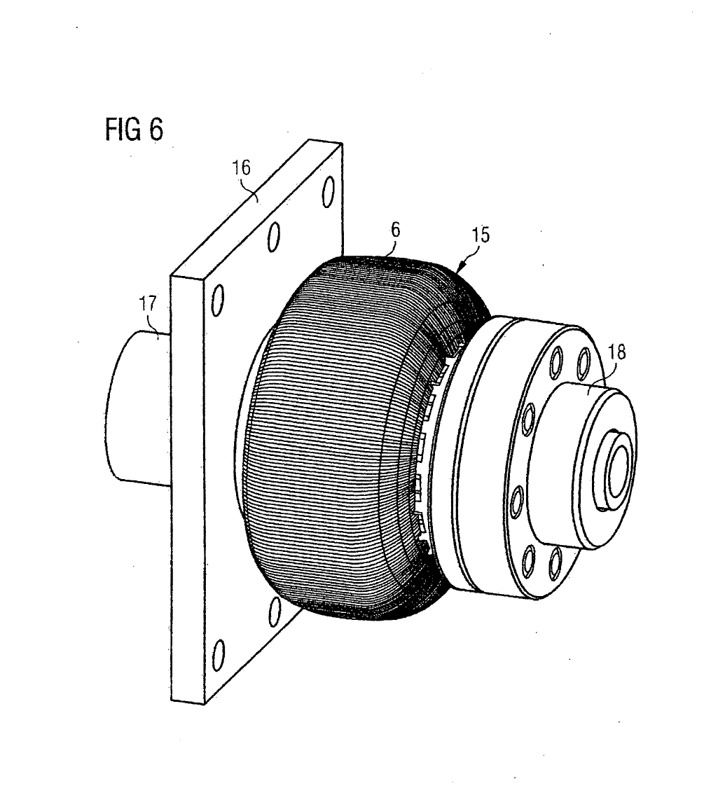

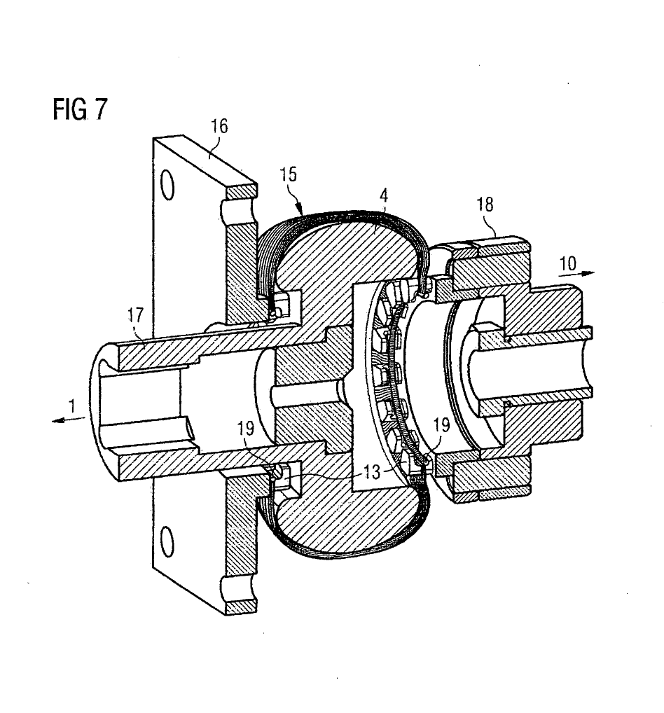

FIGS. 6 and 7 show an embodiment of the cord brake in a perspective complete view or in a cross-sectional view. The same reference characters refer to the same elements. In FIGS. 6 and 7 an embodiment is shown which is discussed as a first embodiment in the description above, i.e. in the case of which the brake body 4 rotates. The first bearing element is integrated in a wall (housing wall or the like) 16, the second bearing element in the actuating device 10 or the motor shaft 18 associated therewith. 15 refers to the brake cord winding (brake cord hose), which can be prefabricated while a brake cord 6 or individual brake cord fibers 6 are wrapped around a ring 19 in each case. The brake cord winding 15 is subsequently positioned around the brake body 4 while the rings 19 are suspended from hooks 13 as connecting elements of the integrated bearing elements. The ring 19 consists of spring steel in an advantageous manner.

From the cross-sectional view of FIG. 7 it can be identified that the brake body 4 is connected to the component 1 via the shaft 17 and in this way follows a rotation of the component 1. The brake cord winding 15 remains motionless in the case of an inactive brake. The left side of the brake cord winding 15 (or the left ring 19) shown in FIG. 7 is connected in a torque-proof manner to the wall 16, while the right side or the right ring 19 is connected to the motor shaft 18 by means of the hooks 13 and in this way can be rotated by the drive unit 10. Because of this, in the case of an active brake, the angular displacement can be produced between the bearing elements or the ring-hook arrangement 19, 13 on the opposite side needed for the braking action.

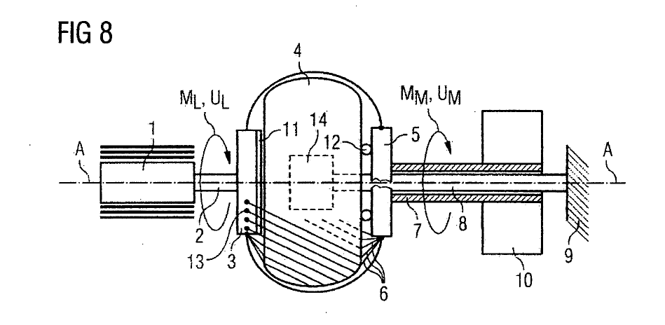

With the aid of FIG. 8 a concrete, non-limiting application of the cord brake as a belt brake with an integrated seat belt tensioner will be explained.

FIG. 8 shows a retractor reel 1 as the component or load to be braked, which is connected to a bearing disk 3 as a bearing element by means of a shaft 2. Apart from that, the diagram corresponds to that shown in FIG. 1, for which reason express reference is made to the exemplary embodiment discussed with reference to FIG. 1. Unlike the design in FIG. 1, the brake body 4 is mounted by means of a schematically shown freewheel 14 on the connecting shaft 8 so that a rotation of the brake body 4 in a direction, here in the direction of rotation of the retractor reel 1 when the seat belt is drawn out, is prevented, while a rotational movement is made possible in the opposite direction. The freewheel 14 can be integrated in the brake body 4 in a preferred manner. However, an integration at another location, for example, on a fixed bearing 9, should not be excluded.

Seat belt systems usually have a rotatable retractor reel, labeled 1 in FIG. 8, onto which a seat belt is wound, as well as a mechanism, which in the case of a crash makes provision for the blocking of the retractor reel and in this way for a braking of a reeling off movement of the seat belt from the retractor reel. In addition, such systems are frequently equipped with a seat belt buckle or a seat belt tensioner fitted to the retractor reel, which pulls the seat belt tight against the body of an occupant inside a motor vehicle immediately before a crash. A possible development of a seat belt tensioner unit is described in DE 10 2004 057 095 B3. In order to prevent injuries caused by the seat belt system, provision is usually also made for a belt force limiter, which limits the effect of the force applied by the seat belt onto the occupants inside a motor vehicle, for example, by the deformation of a torsion bar from a certain seat belt force. Such torsion bars are usually specially designed and manufactured for one motor vehicle type. For the deformation of a torsion bar, it is often the case that only a maximum of two different force levels may be set. For this purpose, reference is usually made to the average values of the height and the weight of an occupant inside a motor vehicle, the seat position, the driving and the crash situation, etc.

In the case of such seat belt systems there is hence the danger that for example in the case of a motor vehicle occupant with a very low body weight, in the case of a crash, the seat belt force level is not achieved for a sufficient deformation of the torsion bar. This leads to an excessive application of force of the seat belt with the result that there is a higher risk of injury to the head and chest areas. However, on the other hand, it is also for example possible in the case of motor vehicle occupants with a high body weight that the braking action of the seat belt system is not sufficient so that there is a risk that these occupants, in the case of a crash, will hit against the steering wheel. In addition, such systems are unable to react to a change in other parameters such as for example an incorrect position of an occupant inside a motor vehicle or specific driving or crash situations.

In the previous German patent application DE 10 2005 041 101.0 of the applicant, an adaptive seat belt system is proposed, which in the case of a crash, makes possible an individual control of the effect of the force applied by the seat belt onto an occupant inside a motor vehicle. This seat belt system comprises a braking system that can be actuated by an actuator (electric motor) to brake a movement of the seat belt. This braking arrangement is equipped with an arrangement for the self-energizing of the actuating force generated by the actuator. For this purpose, a wedge brake shown with reference to FIG. 5 can be used. However, in the present exemplary example, the use of a cord brake is explained. Furthermore, the actuator is connected to an electronic control unit which, to this end, is equipped for controlling the actuator as a function of at least one occupant-specific and/or situation-specific parameter. Such parameters, for example, are the weight of an occupant inside a motor vehicle, the seat position of an occupant inside a motor vehicle, the speed of the motor vehicle, a crash pulse in the case of a crash or the parameters characterizing the ambient situation (for example, the temperature, the condition of the road, the nature of an obstacle). As a function of one of these parameters or a plurality of these parameters, the electronic control unit determines for example a time-dependent desired characteristic curve, according to which the braking process of the reeling-out movement of the seat belt from the retractor reel is controlled. With reference to the details of such an adaptive seat belt system proposed by the applicant, express reference should be made to the said application. The use of a cord brake for such a seat belt system using an exemplary seat belt brake will be described below.

For this purpose, a seat belt is wound onto the retractor reel 1 shown in FIG. 8, which is reeled out in the case of a crash so that a forward displacement with a braking is enabled for the occupant inside a motor vehicle. The retractor reel 1 is connected mechanically to the bearing disk 3 by means of the shaft 2. As a result, a rotating reeling-out movement of said belt from the retractor reel, when drawing out the seat belt, can be braked according to the preceding description (in particular with reference to FIG. 1) so that the seat belt can be reeled out in a regulated (or controlled) manner. For this purpose, the control device of an adaptive seat belt system as described above for braking the drawing out of the seat belt, controls the actuating device 10. Depending on the angular displacement produced between the bearing disks 3 and 5, a given geometry of the brake body 4 and the brake cord winding leads to a braking force, by means of which the retractor reel 1 is braked. With reference to further details, express reference should be made to the previous description.

A further advantage of using a cord brake as a belt brake in the development according to FIG. 8, is that it can also assume the function of a seat belt tensioner so that it is possible to first of all roll up the seat belt immediately in the case of a crash in order to tighten it and to apply it against the body of an occupant inside a motor vehicle. For this purpose, provision is made for the already explained freewheel 14, which can be integrated in the brake body 4 or alternatively in the fixed bearing 9. The freewheel 14 ensures that a rotation of the brake body 4 in the direction of rotation of the retractor reel is prevented in the case of drawing out a seat belt. In this way, during this movement of the retractor reel, the brake body 4 remains in the same place and torque-proof, while the bearing disks 3 and 5 move together with the brake cord winding around the stationary brake body 4. However, the freewheel 14 makes possible a rotatory movement in the opposite direction, which can be used for tensioning the seat belt.

In order to tension the seat belt, the motor or the actuating device 10 rotates against the direction of rotation of the seat belt reeling out, wherein the following shall now apply for the speeds: U_{M}>U_{L}. On the basis of the speed difference (U_{M}≠U_{L}), a braking is again initiated. The braking torque or the braking force rests against the brake body 4 by means of the brake cord 6, it being possible because of the freewheel 14 that the brake body 4 now rotates together with the motor 10 or with the hollow shaft 7. Because of the braking action between the brake cord 6 and the brake body 4, i.e. because of the brake cord wound around the brake body 4 with friction, the shaft 2 of the retractor reel 1 is drawn along by a rotation of the motor 10. In this way, the shaft 2 likewise rotates against the seat belt movement and rolls up the seat belt in this way. Through this, by controlling or regulating the direction of rotation and the speed of the motor 10, a seat belt that is lying loosely against a buckled-up occupant can be tightened.

After the seat belt tensioning phase, which follows immediately and only for a very short time after a detected crash, the already described braking phase of the reeling-out movement of the seat belt follows accordingly in order to protect a motor vehicle occupant from the too high effects of the force of the seat belt and to ensure that the occupant inside a motor vehicle comes to a standstill before making impact with the steering wheel or other objects in the passenger compartment relative to the passenger vehicle cabin.

1.-22. (canceled)

23. A brake for braking a component rotating about an axis of rotation, comprising:
a brake body mounted on the axis of rotation;
two bearing elements mounted on the axis of rotation and arranged one on each side of the brake body;
a brake cord connecting the two bearing elements, wherein the brake body is surrounded at least partly by at least one brake cord; and
an actuating device connected with at least one of the bearing elements to shift the bearing elements relative to one another, wherein based on the shift of the bearing elements the brake cord come into frictional contact with the brake body.

24. The brake as claimed in claim 23, wherein the brake body is mounted torque-proof about the axis of rotation.

25. The brake as claimed in claim 23, wherein the brake body is mounted rotatably about the axis of rotation.

26. The brake as claimed in claim 25, wherein the brake body is connected to the rotating component.

27. The brake as claimed in one of the claims 23, wherein the two bearing elements are mounted in a rotatable manner about the axis of rotation.

28. The brake as claimed in claim 23, wherein at least one of the two bearing elements is mounted about the axis of rotation and is driven by at least one drive unit.

29. The brake as claimed in claim 28, wherein the drive unit is formed of the actuating device.

30. The brake as claimed in claim 23, wherein one of the two bearing elements is mounted in a rotatable manner about the axis of rotation and the other bearing element is mounted in a torque-proof manner about the axis of rotation.

31. The brake as claimed in claim 23, wherein the brake body has a symmetrical design with respect to rotation.

32. The brake as claimed in claim 23, wherein the brake cords surround the brake body equidistantly.

33. The brake as claimed in claim 23, wherein at least one of the bearing elements is mounted in a displaceable manner in a direction of the axis of rotation.

34. The brake as claimed in claim 33, wherein at least one of the bearing elements has a friction lining on a side facing the brake body.

35. The brake as claimed in claim 23, wherein at least one of the bearing elements rests against the brake body via a bearing.

36. The brake as claimed in claim 23, wherein a braking response is within a transition area between a wedge braking response and a band braking response based upon a single length of a brake cord section running over the brake body.

37. The brake as claimed in claim 23, wherein a first bearing element is integrated into the component to be braked, and wherein a second bearing element is integrated into the actuating device.

38. The brake as claimed in claim 23, wherein the brake body has a friction lining on its surface facing the brake cord.

39. The brake as claimed in claim 23, wherein the brake body is mounted via a freewheel about the axis of rotation.

40. A motor vehicle, comprising:
a brake for braking a component rotating about an axis of rotation, comprising:
a brake body mounted on the axis of rotation,
two bearing elements mounted on the axis of rotation and arranged one on each side of the brake body,
a brake cord connecting the two bearing elements, wherein the brake body is at least partly surrounded by at least one brake cord, and
an actuating device connected with at least one of the bearing elements to shift the bearing elements relative to one another, wherein based on the shift of the bearing elements the brake cord come into frictional contact with the brake body.

41. A seat belt system, comprising:
a seat belt brake for braking a component rotating about an axis of rotation, comprising:
a brake body mounted on the axis of rotation,
two bearing elements mounted on the axis of rotation and arranged one on each side of the brake body,
a brake cord connecting the two bearing elements, wherein the brake body is at least partly surrounded by at least one brake cord, and
an actuating device connected with at least one of the bearing elements to shift the bearing elements relative to one another, wherein based on the shift of the bearing elements the brake cord come into frictional contact with the brake body.

42. The seat belt system as claimed in claim 41, wherein the brake cord is selected from the group consisting of a chain, a wire rope, and a woven pattern.
